(19) United States
(12) Patent Application Publication
(10) Pub. No.: US 2024/0069215 A1
(43) Pub. Date: Feb. 29, 2024

(54) METHOD AND APPARATUS FOR LOWERING PROCESSOR LOADING

(71) Applicant: Topcon Positioning Systems, Inc., Livermore, CA (US)

(72) Inventors: Dmitry Anatolyevich RUBTSOV, Moscow (RU); Alexey Stanislavovich LEBEDINSKY, Moscow (RU)

(73) Assignee: Topcon Positioning Systems, Inc., Livermore, CA (US)

(21) Appl. No.: 18/003,694

(22) PCT Filed: Jan. 11, 2022
(86) PCT No.: PCT/RU2022/000004

§ 371 Date: Jul. 20, 2023

(51) Int. Cl. G01S 19/43

(52) U.S. Cl. CPC G01S 19/43

(57) ABSTRACT

A navigation receiver receives a global navigation satellite system signal and processes the signal in a manner that lowers the load on a processor used in the navigation receiver. The navigation receiver includes multiple components that are assembled and configured to detect and respond to events, such as the generation of signals, using a relaxed tick signal that lowers the load on the processor of the navigation receiver.

### FIELD OF THE INVENTION

The present disclosure relates generally to methods for processing signals from different global navigation satellite systems (GNSS), such as GPS or GLONASS, and, more particularly, to methods for lowering processor loading.

### BACKGROUND

The speed of processors in global navigation satellite system receivers must be sufficient so that events that occur, such as the generation of signals, are detected by the processor and responded to accordingly. When a processor is too slow or overloaded, it cannot process events in a timely manner.

U.S. Pat. No. 8,401,546 B2 pertains to a universal acquisition and tracking apparatus for a global navigation satellite system (GNSS). The acquisition and tracking apparatus is described having channels processing an input signal over 1 ms intervals and generating time frames (Code Epoch) which are input to a local interrupt manager. A global time signal at rate 1 ms (Global1 ms) is also generated and serves as an interruption signal. A global interrupt manager distributes the global time signal to each of a plurality of channel processors and collects accumulated data, including at least one of a plurality of correlation signals and sampled carrier and code phase signals, from each of the channel processors and forwards the accumulated data to a computer host for further processing. Correlations are always accumulated and “dumped” to the interrupt handler local interrupt module for processing at the 1 ms rate, whereas feedback signals are updated at the end of the specified total coherent and non-coherent integration periods.

U.S. Pat. No. 8,331,422 B2 pertains to a method and apparatus for acquisition, tracking, and transfer using sub-microsecond time transfer using weak GPS/GNSS signals. A method and apparatus provide high-sensitivity GPS/GNSS signal acquisition in a stationary GPS/GNSS receiver. A control algorithm and apparatus wherein 1 ms correlations of the input signal, pseudorandom noise (PRN) code signal, and output signal of a numerically-controlled oscillator (NCO) are produced and 20 ms symbols are output. The uncertainty in frequency due to apparent Doppler shift is partitioned into a plurality of contiguous frequency bins, and the uncertainty in location of navigation data bit boundaries is partitioned into equally spaced trial bit boundary locations. For example, compensation for Doppler shift is produced by corrections at a rate no greater than 1 Hz/sec.

Although these patents describe configurations that cause processors to operate based on specific intervals, these configurations do not lower the processor's load. What is needed is a method and apparatus for lowering a processor's load so that it can process signals in a timely manner.

### SUMMARY

In one embodiment, a GNSS receiver (also referred to as a navigation receiver) includes an RF-path configured to receive Global Navigation Satellite System (GNSS) signals from an antenna and transmit the GNSS signals via an intermediate frequency. An analog to digital convertor (ADC) is to receive the GNSS signals from the RF-path at the intermediate frequency and sample the GNSS signals at frequency CLKnav. A time scale generator is configured to generate a tick signal and a relax tick signal. A channel configured to receive the GNSS signal from the ADC includes an intermediate frequency numerically controlled oscillator (NCO) configured to generate a pulse at the intermediate frequency and at an intermediate frequency phase. The channel also includes a code rate NCO configured to generate a code rate NCO signal having a code rate NCO phase and a code rate NCO frequency. The channel also includes a code generator configured to generate a code signal based on the code rate NCO frequency. The channel also includes a strobe generator configured to generate a strobe signal based on the shape of the code signal and the code rate NCO phase, an integration period counter configured to generate an integration period signal based on the code rate NCO frequency, and a commutator configured to receive the GNSS signal from the ADC. The channel also includes a correlator configured to multiply a signal output from the commutator, from the code generator, and the intermediate frequency phase from the intermediate frequency NCO to generate a first product, and configured to store the first product during the integration period. The correlator is also configured to multiply the signal output from the commutator, from the strobe signal, and the intermediate frequency phase from the intermediate frequency NCO to generate a second product, and configured to store the second product during the integration period. The navigation receiver also includes a CPU controlling a navigation receiver and reading data from the correlator. A method for operating a navigation receiver is also described

### BRIEF DESCRIPTION OF THE DRAWINGS

FIG. 1 shows a Global Navigation Satellite System (GNSS) receiver according to an embodiment;

FIG. 2 shows details of the time scale generator shown in FIG. 1;

FIG. 3 shows details of one of the channels shown in FIGS. 1 and 2;

FIG. 4 shows details of the correlator shown in FIG. 3;

FIG. 5 shows a timing diagram displaying the relationship between a tick (i.e., a clock pulse signal), an integration period signal and data in primary and secondary buffers according to an embodiment;

FIG. 6 shows a timing diagram displaying the relationship between ticks and read, processing, and write operations according to an embodiment;

FIG. 7 shows a timing diagram displaying the relationship between ticks, relaxed ticks (i.e., a tick generated based on a clock pulse and occurring later in time than the clock pulse) and read, processing, and write operations according to an embodiment;

FIG. 8 shows a GNSS receiver in which a relaxed tick is generated and utilized according to an embodiment;

FIG. 9 shows details of the time scale generator shown in FIG. 8;

FIG. 10 shows details of the channel shown in FIGS. 8 and 9; and

FIG. 11 shows a method for operating a navigation receiver according to an embodiment.

### DETAILED DESCRIPTION

The speed of processors in global navigation satellite system receivers must be sufficient so that events that occur, such as the generation of signals, are detected by the processor and responded to accordingly. This detection and response are required to generate raw measurements. In order to correctly generate raw measurements, the updating of control values at intermediate frequencies and code frequencies according to a tick signal (i.e., a clock pulse) is necessary. Specifically, control values need to be updated according to an event occurring at an exactly known time. The integral of code frequency and intermediate frequency in usage time is used to generate code and phase measurements. Any error in the usage time of a new intermediate frequency and code frequency results in accumulating errors of raw measurements.

The control signals are programmable and generated by tracking algorithms performed by a CPU. The control signals are written to one or more channels at certain times. The control signals cause operations to be performed (e.g., update/copy) that begin based on a known tick signal (e.g., a clock pulse that occurs). This limitation of operations beginning based on a known tick signal applies to strict, real time requirements of program components of a GNSS receiver. Moreover, generation of control signals that last longer than one tick in duration (e.g., the time between two temporally adjacent ticks) and can be interrupted by different tasks, such as reading components from channel correlators and data exchange tasks in communication subsystems. The period of operations performed during a tick cannot be longer than the period of one code duration (1/1023 000=977 ms) less the time required to read data from channels to CPU memory.

A relax tick can be added in order to allow more time for certain operations to occur. The relax tick is a tick that is generated to occur after a tick that would normally occur based on a clock pulse. For example, ticks output from a clock at a rate of two per second would provide a tick frequency of 2 Hz. A relax tick can be generated so that a tick generated by a clock occurs and a relax tick occurs later (e.g., later than the next clock tick after the original tick generated by the clock) in order to provide a tick frequency of 1 Hz. Adding a relax tick postponed relative to the start of generating control signals in frequency by a period of time exceeding the time when a tick generated from a clock pulse occurs, and multiples of the clock pulse, allows a considerable reduction of execution time requirements for algorithms of signal tracking, reducing extra overhead required to provide guaranteed new values. The relax tick is generated less frequently than the tick.

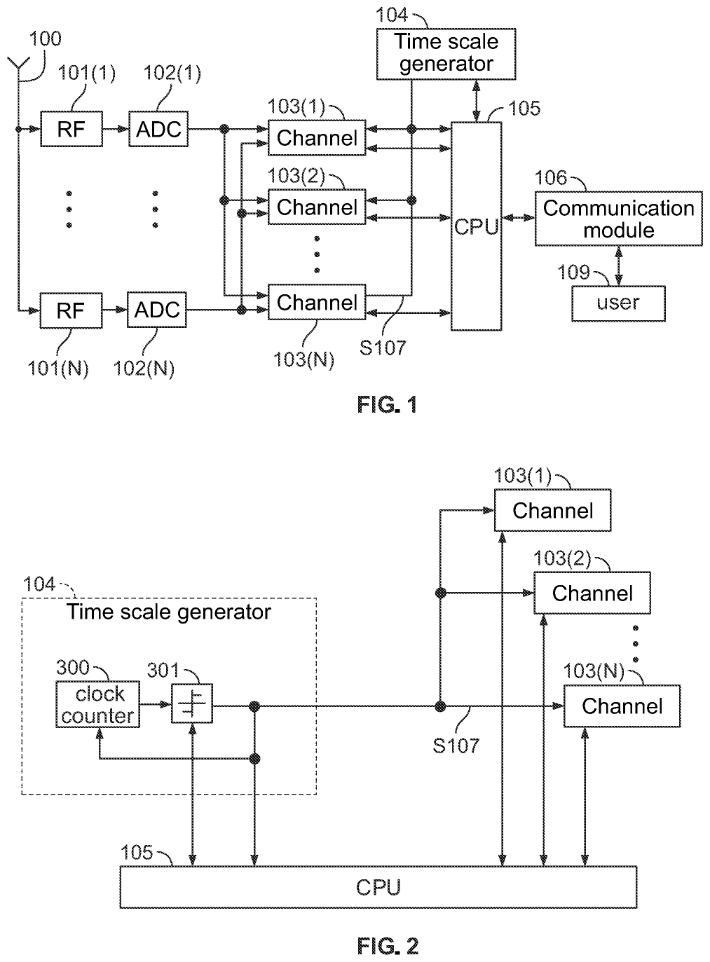

FIG. 1 shows a Global Navigation Satellite System receiver having antenna 100 that receives signals that are input to RF paths 101(1 . . . N). Each of RF paths 101 (1 . . . N) transmits signals to a respective analog to digital converter (ADC) 102(1 . . . N). The output of ADCs 102(1 . . . N) are input to channels 103(1, 2, . . . N). It should be noted that ADCs 102(1 . . . N) and channels 103 (1, 2, . . . N) may be referenced to herein collectively as ADC 102 and channel 103. Other components that are similarly numbered may be similarly referred to collectively. Channels 103(1, 2, . . . N) are also connected to time scale generator 104. Channels 103(1, 2, . . . N) receive tick signal S107 from time scale generator 104. A tick signal is also transmitted from time scale generator 104 to central processing unit (CPU) 105 (also referred to as a processor). CPU 105 can transmit to, and receive information from, user 109 via communication module 106.

In one embodiment, CPU 105 controls channel 103 and time scale generator 104. In one embodiment, the receiver shown in FIG. 1 operates as follows. Before receiver operation, CPU 105 adjusts time scale generator 104. Time scale generator 104 generates a tick signal S107 (tick) with equal time instants.

A satellite signal is received by antenna 100 and passes through the RF-path 101 and ADC 102 and is then input to channel 103. Channel 103 processes the signal from ADC 102. Time scale generator 104 generates a clock cycle (tick). CPU 105 controls channel 103 and time scale generator 104. CPU 105 also processes information received from channels 103 when the tick signal S107 is available and, through communications module 106, transmits generated data to user 109 via communications module 106. In one embodiment, ADC 102, channel 103 and time scale generator 104 operate at clock CLKnav.

FIG. 2 shows details of time scale generator 104 shown in FIG. 1. In one embodiment, time scale generator 104 comprises clock counter 300 which is in communication with CPU 105 and threshold unit 301. In one embodiment, time scale generator 104 operates as follows.

Before operation of time scale generator 104 begins, CPU 105 assigns a threshold value to threshold unit 301. Before operation begins, the value in clock counter 300 is 0. The value of clock counter 300 increases by 1 for each pulse of clock CLKnav. The value of clock counter 300 is transmitted to the input of threshold unit 301. If the value is equal to the threshold value assigned to threshold unit 301 by CPU 105, then the output of threshold unit 301 is 1. If the value of clock counter 300 is not equal to the threshold value, then the output of threshold unit 301 is 0. The output signal from threshold unit 301 is input to channel 103, clock counter 300, and to CPU 105 as an interruption. If the output signal of threshold unit 301 is equal to 1, then clock counter 300 is reset at next clock (e.g., set equal to 0). Tick signal S107 is the output signal of the threshold unit of clock counter 301.

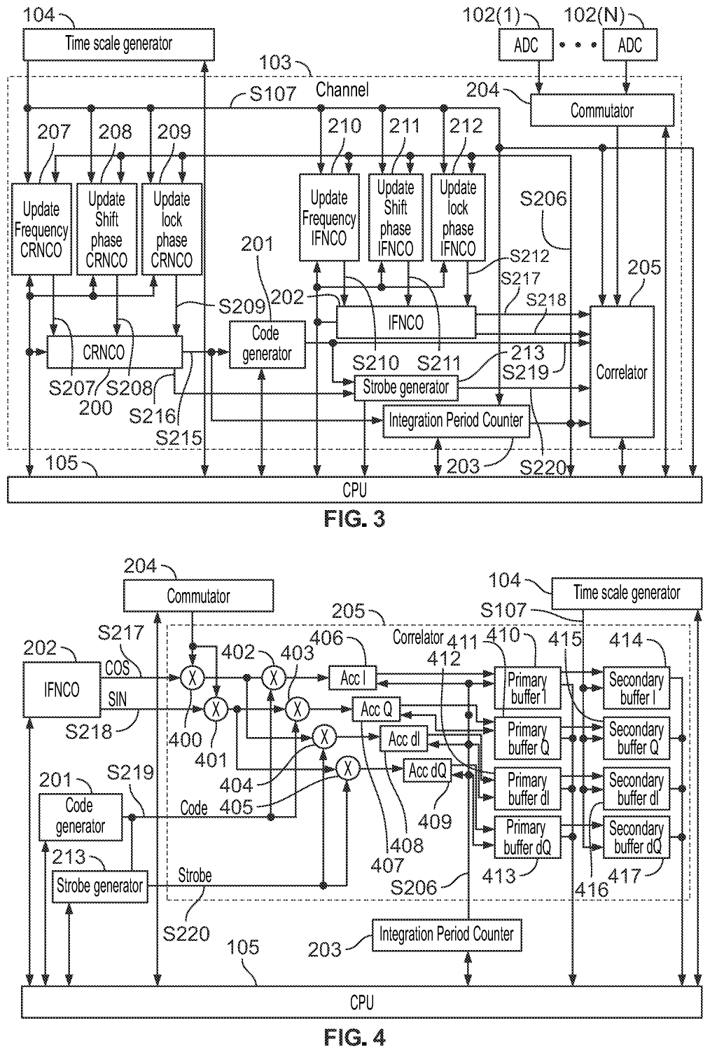

FIG. 3 shows details of channel 103 shown in FIGS. 1 and 2. In one embodiment, channel 103 comprises code rate numerically-controlled oscillator (NCO) referred to as CRNCO 200, code generator 201, intermediate frequency NCO (IFNCO) 202, integration period counter 203, commutator 204, correlator 205, integration period signal S206, update frequency CRNCO 207, update shift phase CRNCO 208, update lock phase CRNCO 209, update frequency IFNCO 210, update shift phase IFNCO 211, update lock phase IFNCO 212, update frequency CRNCO signal S207, update shift phase CRNCO signal S208, update lock phase CRNCO signal S209, update frequency IFNCO signal S210, update shift phase IFNCO signal S211, update lock phase IFNCO signal S212, strobe generator 213, code frequency signal S215, code phase signal S216, COS cosine signal S217, SIN sine signal S218, code (PRN Code signal) S219, strobe signal S220. Update CRNCOs 207, 208, and 209 and update IFNCOs 210, 211, and 212 are also referred to as units.

In one embodiment, CPU 105 controls and/or receives data from CRNCO 200, code generator 201, IFNCO 202, integration period counter 203, commutator 204, correlator 205, update frequency CRNCO 207, update shift phase CRNCO 208, update lock phase CRNCO 209, update frequency IFNCO 210, update shift phase IFNCO 211, update lock phase IFNCO 212, and strobe generator 213.

In one embodiment, signals are transmitted between components as follows. Update frequency CRNCO signal S207 is output from update frequency CRNCO 207 and transmitted to input of CRNCO 200. Update shift phase CRNCO signal S208 is output from update shift phase CRNCO 208 and transmitted to input of CRNCO 200. Update lock phase CRNCO signal S209 is output from update lock phase CRNCO 209 and transmitted to input of CRNCO 200.

Update Frequency IFNCO signal S210 is output from update frequency IFNCO 210 and transmitted to input of IFNCO 202. Update shift phase signal IFNCO S211 is output from update shift phase IFNCO 211 and transmitted to input of IFNCO 202. Update lock phase IFNCO signal S212 is output from update lock phase IFNCO 212 and transmitted to input of IFNCO 202. Signals S207, S208, S209, S210, S211, and S212 are also referred to as update signals.

In one embodiment, CPU 105 controls CRNCO 200. CPU 105 assigns a code frequency and an interface register, assigns a value for CRNCO 200, and updates/copies data from the interface register to the buffer (which operates at clock frequency CLKnav) based on signal S207. CPU 105 enters the code phase shift into the interface register, and the code phase shift from the interface register is added to the current code phase based on signal S208 and the code phase shift in the interface register is set equal to 0. CPU 104 copies the current state of code phase in the code lock phase register in CRNCO 200, and this value is updated based on signal S209.

In one embodiment, CPU 105 controls IFNCO 202 as follows. CPU 105 enters intermediate frequency into the interface register, assigns a value for IFNCO 202, updates/copies data from the interface register to the buffer register (which operates at clock frequency CLKnav) based on signal S210. CPU 105 enters intermediate frequency phase shift into the interface register, and based on signal S211, intermediate frequency phase shift from the interface register is added to the current intermediate frequency phase, and the intermediate frequency phase shift in the interface register is set equal to 0. CPU 105 copies the current intermediate frequency phase in IFNCO 202 into intermediate frequency lock phase and this value is updated based on signal S212.

When CPU 105 writes a new value in the code frequency interface register in CRNCO 200, an immediate signal is generated in unit 207. When CPU 105 writes a new value in the interface register of code phase shift in CRNCO 200, an immediate signal is generated in unit 208. When CPU 105 writes a new value in the register of the code frequency lock phase in CRNCO 200, an immediate signal is generated in unit 209. When CPU 105 writes a new value in the interface register of intermediate frequency in IFNCO 202, an immediate signal is generated in unit 210. When CPU 105 writes a new value in the interface register of intermediate frequency phase shift in IFNCO 202, an immediate signal is generated in unit 211. When CPU 105 writes a new value in the interface register of intermediate frequency lock phase in IFNCO 202, an immediate signal is generated in unit 212. Immediate signal is one clock cycle CLKnav.

In one embodiment, CPU 105 controls units 207, 208, 209, 210, 211, and 212, and update signals are generated at the output of these units. Each unit 207, 208, 209, 210, 211, and 212 has its own/independent control.

In one embodiment, tick signal S107 and integration period signal S206 are fed to the output of each of units 207, 208, 209, 210, 211, and 212. Single-clock/one-clock signals can cause update signals to be output from units 207, 208, 209, 210, 211, and 212.

In one embodiment, an immediate signal is generated and output from one of CPU controlled units 207, 208, 209, 210, 211, and 212 after a value is written into the register of a corresponding one of the controlled units. An integration period signal S206 is the signal of the integration period ending and is generated by integration period counter 203. Tick signal S107 is generated by time scale generator 104. Table 1 shows output signals of units 207, 208, 209, 210, 211, and 212 based on signals from CPU 105.

TABLE 1

| | Signal at the output of units |
|---|---|
| CPU 105 controlled units | 207/208/209/210/211/212 serving as |
| 207/208/209/210/211/212 | Update signal |
| 00 | Immediate signal |
| 01 | Integration Period signal S206 |
| 10 | Tick signal S107 |
| 11 | Not used |

Based on tick signal S107, the current state of integration period counter 203 is copied into a register of a lock state of the integration period counter.

The lock state of the integration period counter, the intermediate frequency lock phase in IFNCO 202, and the lock phase register in CRNCO 200 are used for pseudo range calculation and operate based on tick signal S107. IFNCO 202 generates and outputs two signals, namely cosine and sine signals.

In one embodiment, initialization of the channel shown of FIG. 3 is as follows. Before beginning operation of the channel of FIG. 3, CPU 105 adjusts code generator 201, commutator 204, units 209 and 212, and strobe generator 213 and also performs the following operations. CPU 105 sets code frequency in CRNCO 200. If needed, CPU 105 assigns a code phase shift in CRNCO 200. CPU 105 selects units 207 and 208 as an update signal and tick signal S107. CPU 105 sets intermediate frequency in IFNCO 202. If needed, CPU 105 sets intermediate frequency phase shift in IFNCO 202. CPU 105 selects the outputs of units 210 and 211 as an update signal and tick signal S107. CPU 105 sets the duration of integration period S206 in integration period counter 203.

In one embodiment, the operation of the channel shown in FIG. 3 is as follows. Tick signal S107 output from time scale generator 104 is input to update frequency CRNCO 207, update shift phase CRNCO 208, update lock phase CRNCO 209, update frequency IFNCO 210, update shift phase IFNCO 211, update lock phase IFNCO 212, integration period counter 203, correlator 205, and CPU 105. CRNCO 200 generates code frequency based on tick signal S107. Code frequency S215 is output from CRNCO 200 and input to code generator 201, wherein code signal S219 is generated with this frequency. Code frequency output from CRNCO 200 is input to integration period counter 203 wherein integration period signal S206 counts out the needed duration with the received code frequency. Code signal S219 from code generator 201 is input to correlator 205 and strobe generator 213. Code phase signal S216 from the output of CRNCO 200 is input to strobe generator 213. Strobe generator 213 generates strobe signal S220 which is input to correlator 205.

In one embodiment, integration period signal S206 output from integration period counter 203 is input to correlator 205, frequency update CRNCO 207, shift phase update CRNCO 208, lock phase update CRNCO 209, frequency update IFNCO 210, shift phase update IFNCO 211, lock phase update IFNCO 212, and CPU 105.

In one embodiment, IFNCO 202 generates an intermediate frequency based on tick signal S107. Intermediate frequency phase signals (signals COS S217 and SIN S218) output from IFNCO 202 are input to correlator 205.

In one embodiment, a digitized signal is output from ADC 102 and input to commutator 204. One of the selected signals output from commutator 204 is input to correlator 205.

FIG. 4 shows details of correlator 205 shown in FIG. 3. In one embodiment, correlator 205 comprises multiplication units 400, 401, 402, 403, 404, 405, accumulator I (Acc I) 406, accumulator Q (Acc Q) 407, accumulator dI (Acc dI) 408, accumulator dQ (Acc dQ) 409, primary buffer I 410, primary buffer Q 411, primary buffer dI 412, primary buffer dQ 413, secondary buffer I 414, secondary buffer Q 415, secondary buffer dI 416, and secondary buffer dQ 417.

In correlator 205, the intermediate frequency phase signals from IFNCO 202 (signals COS S217 and SIN S218) are multiplied by the digitized signal output from commutator 204 and code signal S219 output from code generator 201. Also, in correlator 205, the intermediate frequency phase signals from IFNCO 202 (signals COS S217 and SIN S218) are multiplied by the digitized signal output from commutator 204 and strobe signal S220 output from strobe generator 213.

The multiplication product accumulates and is stored over a time period where the time period is based on integration period signal S206. The stored numbers are copied into primary buffers 410, 411, 412, and 413 in correlator 205 and set to zero according to integration period signal S206. Correlator 205 generates components I, Q, dI, and dQ which are read by CPU 105. The values are copied into secondary buffers 414, 415, 416, and 417 from primary buffers 410/411/412/413 based on tick signal S107.

In one embodiment, CPU 105 changes/assigns/reads the following, if needed, during operation: changes code frequency in CRNCO 200, assigns code phase shift in CRNCO 200, changes control of units 207, 208, 209, 210, 211, 212, changes intermediate frequency in IFNCO 202, assigns intermediate frequency phase shift in IFNCO 202, reads the register of code frequency lock phase in CRNCO 200, reads the register of intermediate frequency lock phase in IFNCO 202, reads the register of the lock state of integration period counter 203, reads primary buffers 410, 411, 412, and 413 in correlator 205, and reads secondary buffers 414, 415, 416, and 417 in correlator 205.

In one embodiment, the operation of strobe generator 213 is as described in U.S. Pat. No. 7,764,226 with respect to the universal strobe generator 500 shown in FIG. 2. U.S. Pat. No. 7,764,226 is incorporated by reference herein.

In one embodiment, the correlator shown in FIG. 4 operates as follows. The digitized signal output from commutator 204 and cosine signal S217 output from IFNCO 202 are input to multiplication unit 400 where the signals are multiplied. The digitized signal output from commutator 204 and sine signal S218 output from IFNCO 202 are input to multiplication unit 401 where the signals are multiplied. The result of multiplication by unit 400 and code signal S219 from code generator 201 are input to multiplication unit 402 where the signals are multiplied. The result of multiplication by unit 401 and code signal S219 from code generator 201 are input to multiplication unit 403 where the signals are multiplied. The result of multiplication by unit 400 and strobe signal S220 from strobe generator 213 are input to multiplication unit 404 where the signals are multiplied. The result of multiplication by unit 401 and strobe signal S220 from strobe generator 213 are input to multiplication unit 405 where the signals are multiplied. Integration period signal S206 output from integration period counter 203 is transmitted to the inputs of units 406, 407, 408, 409, 410, 411, 412, and 413. The result of multiplication by unit 402 is input to accumulator I 406, where it is stored during the acting integration period signal S206. The result of multiplication by unit 403 is input to accumulator Q 407, where it is stored during the acting integration period signal S206 The result of multiplication by unit 404 is input to accumulator dI 408, where it is stored during the acting integration period signal S206. The result of multiplication by unit 405 is input to accumulator dQ 409, where it is stored during the acting integration period signal S206.

In one embodiment, based on integration period signal S206: the stored value from accumulator I 406 is copied to primary buffer I 410, the value stored in accumulator I 406 is set to value 0, the value stored in accumulator I 407 is copied to primary buffer Q 411, the value stored in accumulator I 407 is set to value 0, the value stored in accumulator I 408 is copied to primary buffer dI 412, the value stored in accumulator I 408 is set to value 0, the value stored in accumulator I 409 is copied to primary buffer dQ 413, and the value stored in accumulator I 409 takes on value 0.

In one embodiment, based on tick signal S107 and integration period signal S206: the value in primary buffer I 410 is copied to secondary buffer I 414, the value from primary buffer Q 411 is copied to secondary buffer Q 415, the value in primary buffer dI 412 is copied to secondary buffer dI 416, the value in primary buffer dQ 413 is copied to secondary buffer dQ 417.

In one embodiment, CPU 105 reads values from: primary buffer I 410, primary buffer Q 411, primary buffer dI 412, primary buffer dQ 413, secondary buffer I 414, secondary buffer Q 415, secondary buffer dI 416 and, secondary buffer dQ 417. The period of tick signal S107 is selected to be a value less than the minimum integration period signal S206 that is used. Storage of values in secondary buffers 414, 415, 416, and 417 over the period of acting tick signal S107, guarantees the reading of these values even if the values in primary buffers 410, 411, 412, and 413 have been changed (these values have been updated according to Integration period signal S206).

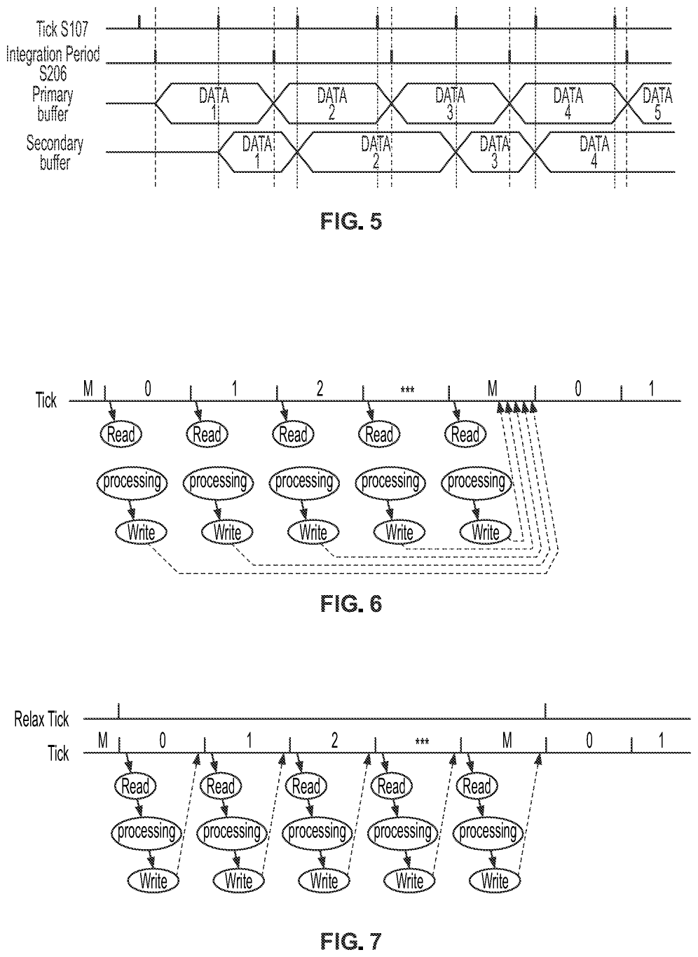

FIG. 5 shows a timing diagram displaying the relationship between tick signal S107, integration period S206 and data in primary and secondary buffers. If values have been changed in channel 103 in primary buffer 410, 411, 412, and 413 during the period tick signal S107, then new components are written in correlator 205 I, Q, dI, and dQ based on integration period signal S206. Based on tick signal S107, values from primary buffer 410, 411, 412, and 413 are copied to secondary buffer 414, 415, 416, and 417. Values from units 414, 415, 416, and 417 are read once in the next period of tick signal S107 and the values read from units 414, 415, 416, and 417 are processed by CPU 105.

FIG. 6 shows a timing diagram displaying the relationship between ticks and read, processing, and write operations. In one embodiment, updating of control values for the intermediate frequency and the code frequency are based on the occurrence of a tick. Specifically, correct generation of raw data is required to be based on the event occurring at the precise known moment of time. The integral of code frequency and intermediate frequency in usage time is used to form a replica in correlator 205 of channel 103 and the replica is used to generate code and phase measurements. Any error in the usage and/or applying of the time of a new value of intermediate frequency and code frequency results in accumulating errors in raw data.

In one embodiment, the control signals themselves are programmable and are generated by tracking algorithms in CPU 105. In one embodiment, the control signals are written in interface registers of channel 103 at certain time moments. They are written (e.g., updated and/or copied from the interface register to buffer register in CRNCO 200 and IFNCO 202) starting from a tick signal. This limitation can apply in strict real time requirements to program components of GNSS receiver. In addition, generation of control signals can last longer than one tick duration and can be interrupted by different tasks, such as reading from channel 103, exchange data tasks etc. The period for forming a tick event cannot be longer than the storage period of one code duration (e.g., 1/1023 000=977 ms).

In one embodiment, adding a relax tick event postponed relative to the beginning of generating control signals in code frequency and intermediate frequency for times exceeding one or multiple ticks allows a decrease of execution time requirements for signal tracking algorithms and avoids unnecessary burdens to guarantee the use of a new control value for IFNCO and CRNCO. FIG. 7 shows a timing diagram displaying the relationship between relaxed ticks and read, processing, and write operations.

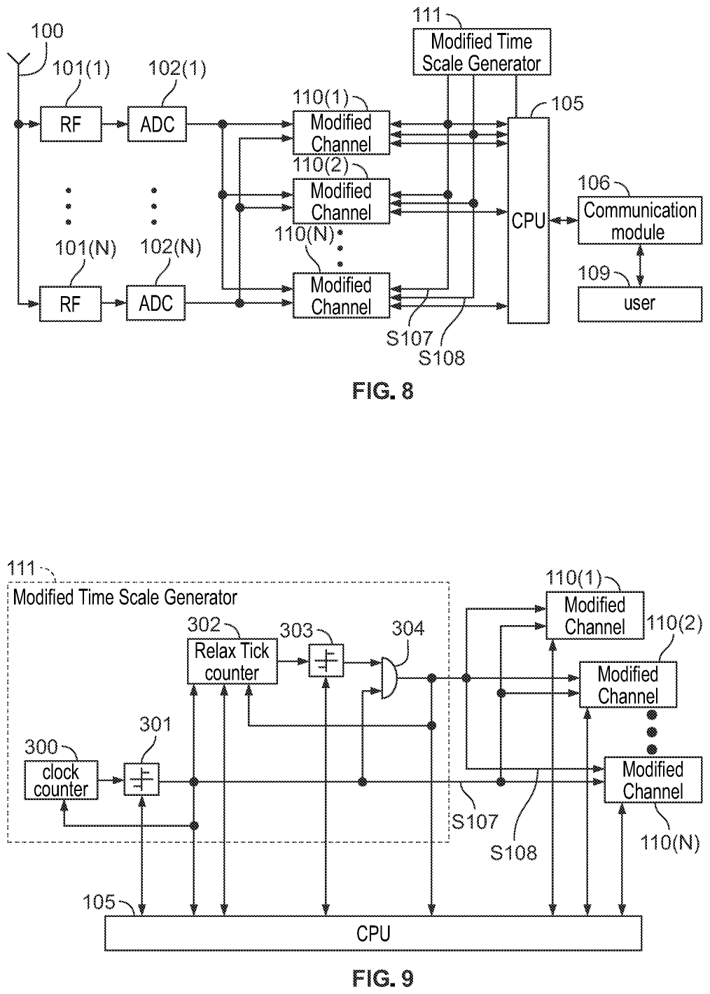

FIG. 8 shows a receiver in which a relaxed tick is generated and utilized according to one embodiment. The receiver shown in FIG. 8 has components that are similar to the components of the receiver shown in FIG. 1. However, some of the components of the receiver shown in FIG. 8 are different from the corresponding components of the receiver shown in FIG. 1. The components/signals of FIG. 8 that are different are identified by the term “modified”. The differences allow the receiver of FIG. 8 to generate and utilize the relaxed tick. Differences between the receiver shown in FIG. 8 and the receiver show in FIG. 1 are as follows. Channel 103 (1 . . . N) is replaced by modified channel 110 (1 . . . N). Time scale generator 104 is replaced by modified time scale generator 111. A relax tick signal S108 is output from modified time scale generator 111. Relax tick signal S108 is input to modified channel 110 (1 . . . N) and CPU 105 as an interruption signal.

FIG. 9 shows details of modified time scale generator 111 shown in FIG. 8. In one embodiment, modified time scale generator 111 comprises relax tick counter 302, threshold relax tick counter 303, and AND gate 304.

In one embodiment, modified time scale generator 111 operates as follows. Before operation, CPU 105 assigns a threshold value in threshold clock counter 301 and a threshold value in relax tick Counter 303. Also, before operation, clock counter 300 and relax tick counter 302 are at a value of 0. Clock counter 300 adds 1 each clock CLKnav.

The current value of clock counter 300 is input to unit 301. If the value of clock counter 300 is equal to the threshold value of unit 301 assigned by CPU 105, then unit 301 outputs a value of 1, otherwise, unit 301 outputs a value of 0. The output of unit 301 is input to channel 103, clock counter 300, relax tick counter 302, AND gate 304, and CPU 105 as an interruption signal. If the output value of unit 301 is a value of 1, then clock counter 300 is reset at next clock (i.e., clock counter 300 is set equal to a value of 0 at next clock).

Tick signal S107 is the output of threshold clock counter 301. When tick signal S107 is available, relax tick counter 302 adds a value of 1. The value of relax tick counter 302 is input to the input of unit 303. If the value in relax tick counter 302 is equal to the threshold of relax tick counter 303 assigned by CPU 105, then unit 303 outputs a value of 1, otherwise, unit 303 outputs a value of 0. The output of unit 303 is input to AND gate 304. If the output signal of unit 303 and tick signal S107 are available, AND gate 304 outputs a value of 1, otherwise AND gate 304 outputs a value of 0. The output of unit 304 is input to modified channel 110, relax tick counter 302, and to CPU 105 as an interruption signal. If unit 304 outputs a value of 1, then unit 302 is reset at next clock (i.e., unit 302 is set equal to a value of 0).

Relax tick signal S108 is output from AND gate 304. CPU 105 can read the value of unit 302. During operation of modified time scale generator 111, CPU 105 can change the threshold value of relax tick Counter 303, if needed.

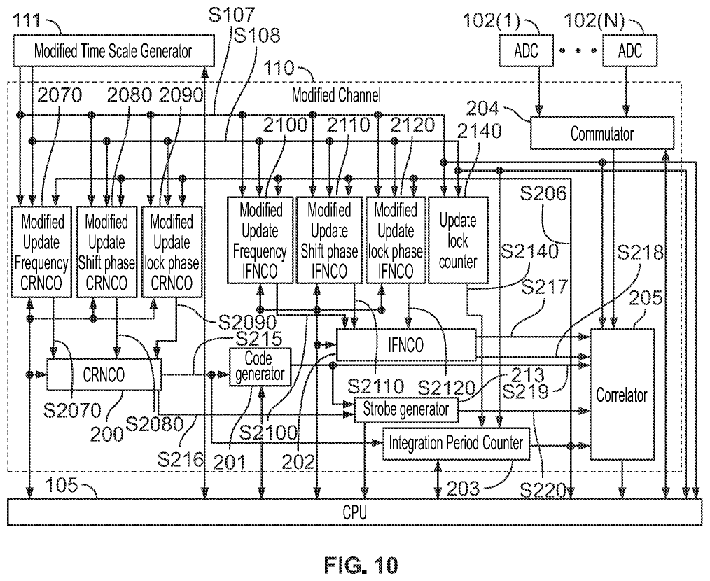

FIG. 10 shows details of modified channel 110 shown in FIGS. 8 and 9. Modified channel 110 comprises the components and signals of channel 103 and the following differences: update frequency CRNCO 207 is replaced by modified update frequency CRNCO 2070. Update phase shift CRNCO 208 is replaced by modified update phase shift CRNCO 2080. Update lock phase CRNCO 209 is replaced by modified update lock phase CRNCO 2090. Update frequency IFNCO 210 is replaced by modified update frequency IFNCO 2100. Update phase shift IFNCO 211 is replaced by modified update phase shift IFNCO 2110. Update lock phase IFNCO 212 is replaced by modified update lock phase IFNCO 2120. Modified CRNCO Frequency update signal S2070 is output from modified update frequency CRNCO 2070. Modified CRNCO phase shift update signal S2080 is output from modified update phase shift CRNCO 2080. Modified CRNCO lock phase update signal S2090 is output from modified update lock phase CRNCO 2090. Modified IFNCO frequency update signal S2100 is output from modified update frequency IFNCO 2100. Modified IFNCO phase shift update signal S2110 is output from modified update phase shift IFNCO 2110. Modified IFNCO lock phase update signal S2120 is modified output from update lock phase IFNCO 2120. Lock counter update signal S2140 is output from update lock counter 2140.

In one embodiment, CPU 105 controls CRNCO 200 as follows: CPU 105 sets code frequency in the interface register, updates and/or copies the value in CRNCO 200 from the interface register to the buffer (which operates at clock CLKnav) using signal S2070. CPU 105 places code phase shift in the interface register, copies data from the interface register to the buffer register (which operates at clock CLKnav), code phase shift from the buffer register is added to the current code phase based on signal S2080, and code phase shift in the buffer register is set equal to 0. The current state of code phase in CRNCO 200 is copied into the register of lock code phase, the value being updated using signal S2090.

In one embodiment, CPU 105 controls IFNCO 202 as follows: CPU 105 sets intermediate frequency in the interface register, the value of IFNCO 202 is updated and/or copied from the interface register to the buffer (which operates at clock CLKnav) by signal S2100. CPU 105 sets intermediate frequency phase shift in the interface register, copies data from the interface register to the buffer register (which operates at clock CLKnav), intermediate frequency phase shift from the buffer register is added to the current intermediate frequency phase by signal S2110, and intermediate frequency phase shift in the buffer register is set to a value of 0. CPU 105 copies the current state of intermediate frequency phase of IFNCO 202 in intermediate frequency lock phase register, the value being updated by signal S2120.

When CPU 105 writes a new value in the interface register of code frequency in CRNCO 200, an immediately signal is generated in unit 2070, which operates at clock CLKnav. When CPU 105 writes a new value in the interface register of code phase shift in CRNCO 200, an immediately (phase shift) signal is generated in unit 2080, which operates at clock CLKnav. When CPU 105 writes a new value in the interface register of lock phase in CRNCO 200, an immediately (lock phase) signal is generated in unit 2090, which operates at clock CLKnav. When CPU 105 writes a new value in the interface register of intermediate frequency in IFNCO 202, an immediately signal is generated in unit 2100, which operates at clock CLKnav. When CPU 105 writes a new value in the interface register of intermediate frequency (phase shift) in IFNCO 202, an immediately signal is generated in unit 2110, which operates at clock CLKnav. When CPU 105 writes a new value in the interface register of intermediate frequency lock phase in IFNCO 202, an immediately signal is generated in unit 2120.

In one embodiment, CPU 105 controls units 2070, 2080, 2090, 2100, 2110, and 2120, with update signals being output from each unit. Each unit 2070, 2080, 2090, 2100, 2110, and 2120 has its own independent control.

Tick signal S107, relax tick signal S108, and integration period signal S206 are fed to the output of each unit 2070, 2080, 2090, 2100, 2110, and 2120. The following one-clock signals can be update signals at the output of units 2070 2080 2090 2100 2110 2120: Immediate signal is a signal that is generated after writing in the register. Integration period signal S206 is a signal identifying the ending of the integration period and it is generated by integration period counter 203. Tick signal S107 is a signal that is generated by time scale generator 111. Relax tick signal S108 is generated by time scale generator 111. The control of units 2070, 2080, 2090, 2100, 2110, and 2120 and signals output by those units based on control signals is shown in Table 2.

TABLE 2

| Control of units | Signal at the output of units |
|---|---|
| 2070/2080/2090/2100/2110/2120 | 2070/2080/2090/2100/2110/2120 as |
| set by CPU 105 | Update signal |
| 00 | Immediate signal |
| 01 | Integration Period signal S206 |
| 10 | Tick signal S107 |
| 11 | Relax Tick signal S108 |

CPU 105 controls unit 2140 to output an update signal. Tick signal S107, relax tick signal S108 are also output from unit 2140. The following one-clock signals can be update signals output from unit 2140: Tick signal S107 is a signal that is generated by Modified time scale generator 111. Relax tick signal S108 is a signal that is generated by modified time scale generator 111.

The current state of integration period counter 203 is copied to the register of the lock integration period by lock counter update signal S2140. The control of unit 2140 and signals output by unit 2140 are shown in Table 3.

TABLE 3

| Control of unit 2140 set | Signal at the output of unit 2140 as |
|---|---|
| by CPU 105 | Update signal |
| 00 | Not used |
| 01 | Not used |
| 10 | Tick signal S107 |
| 11 | Relax Tick signal S108 |

In one embodiment, IFNCO 202 outputs two signals, namely COS S217 and SIN S218.

In one embodiment, initialization of the receiver shown in FIG. 10 is as follows. Before the receiver begins to operate, CPU 105 performs the following operations: CPU 105 sets code frequency in CRNCO 200. If needed, CPU 105 also sets code phase shift in CRNCO 200. CPU 105 selects tick signal S107 as an update signal for units 2070 and 2080. CPU 105 sets intermediate frequency in IFNCO 202. If needed, CPU 105 also sets intermediate frequency phase shift in IFNCO 202. CPU 105 selects tick signal S107 as update signal for units 2100 and 2110. CPU 105 adjusts code generator 201 and sets integration period signal S206 in integration period counter 203. CPU 105 adjusts commutator 204 and units 2090, 2120, and 2140 and strobe generator 213.

In one embodiment, the receiver shown in FIG. 10 operates as follows. Tick signal S107 output from modified time scale generator 111 is input to: modified CRNCO Frequency update 2070, modified CRNCO phase shift update 2080, modified CRNCO lock phase update 2090, modified IFNCO frequency update 2100, modified IFNCO phase shift update 2110, modified IFNCO lock phase update 2120, lock counter update unit 2140 and correlator 205.

In one embodiment, relax tick signal S108 from the output of modified time scale generator 111 is input to the following units: modified CRNCO frequency update 2070, modified CRNCO phase shift update 2080, modified CRNCO lock phase update 2090, modified IFNCO frequency update 2100, modified IFNCO phase shift update 2110, modified IFNCO lock phase update 2120, and lock counter update unit 2140.

CRNCO 200 generates a code frequency based on tick signal S107. Code frequency signal S215 is output from CRNCO 200 and input to code generator 201, and code signal S219 is generated with this frequency. Code frequency output from CRNCO 200 is input to integration period counter 203, wherein the assigned duration of integration period signal S206 is counted out with this frequency. Code signal S219 from code generator 201 is input to correlator 205 and strobe generator 213. Code phase signal S216 output from CRNCO 200 is input to strobe generator 213. Strobe generator 213 generates strobe signal S220 which is input to correlator 205. Integration period signal S206 from the output of integration period counter 203 is input to: correlator 205, modified CRNCO frequency update 2070, modified CRNCO phase shift update 2080, modified CRNCO lock phase update 2090, modified IFNCO frequency update 2100, modified IFNCO phase shift update 2110, modified IFNCO lock phase update 2120, lock counter update unit 2140, and CPU 105.

IFNCO 202 generates the intermediate frequency according to tick signal S107. Intermediate frequency phase (e.g., COS S217 and SIN S218 signals) are output from unit IFNCO 202 and input to Correlator 205. The digitized signal output from ADC 102 is input to commutator 204. One of the selected digitized signals output from commutator 204 is input to correlator 205.

In correlator 205, intermediate frequency phase from IFNCO 202 is multiplied by the digitized signal output from commutator 204 and code signal S219 output from code generator 201.

In correlator 205 intermediate frequency phase from unit IFNCO 202 is multiplied by the digitized signal output from commutator 204 and strobe signal S220 output from strobe generator 213.

The multiplication result accumulates and is stored over the duration of integration period signal S206. Based on integration period signal S206, the stored values are copied into primary buffers 410, 411, 412, and 413 of correlator 205 and zeroed. Correlator 205 generates components I Q dI dQ which are read by CPU 105. From primary buffers 410, 411, 412, and 413 based on tick signal S107, the values are copied into secondary buffers 414, 415, 416, and 417.

After starting modified channel 110, CPU 105 selects relax tick signal S108 as update signal for units 2070, 2080, 2100, and 2110. If needed, CPU 105 performs the following operations: changes code frequency in CRNCO 200, sets code phase shift in CRNCO 200, changes control in units 2070, 2080, 2090, 2100, 2110, 2120, and 2140, changes intermediate frequency in IFNCO 202, sets intermediate frequency phase shift in IFNCO 202, reads the register of the code frequency lock phase in CRNCO 200, reads the register of intermediate frequency lock phase in IFNCO 202, reads the register of the lock state in Integration Period Counter 203, reads primary buffers 410, 411, 412, and 413 in correlator 205, reads secondary buffers 414, 415, 416, and 417 in correlator 205. In one embodiment, all update signals operate at clock CLKnav.

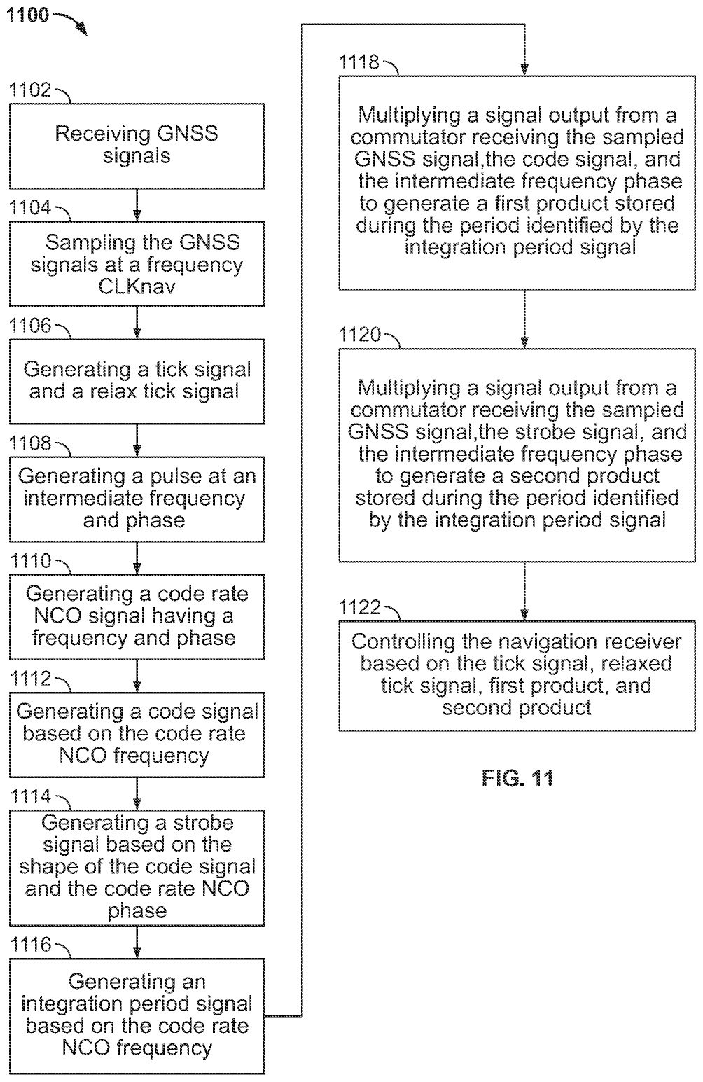

FIG. 11 shows a flow chart of method 1100 for operating a navigation receiver according to an embodiment. The method steps are performed by the components of a navigation receiver as described above. The method begins at step 1102 where GNSS signals are received. In one embodiment, the signals are received at an RF-path from an antenna. In one embodiment, the GNSS signals are transmitted from the RF-path at an intermediate frequency. At step 1104, the GNSS signals are sampled at frequency CLKnav. In one embodiment, the GNSS signals are sampled by an ADC which receives the GNSS signals from the RF-path. At step 1106, a tick signal and a relax tick signal are generated. In one embodiment, the tick signal and relax tick signal are generated by a time scale generator. At step 1108, a pulse is generated at an intermediate frequency and intermediate frequency phase. In one embodiment, the pulse is generated by an IFNCO. At step 1110 a code rate NCO signal is generated. In one embodiment, the code rate NCO signal is generated by a code rate NCO and has a frequency and phase. At step 1112, a code signal is generated based on the code rate NCO frequency. In one embodiment, the code signal is generated by a code generator. At step 1114, a strobe signal is generated based on the shape of the code signal and the code rate NCO phase. In one embodiment, the strobe signal is generated by a strobe generator. At step 1116, an integration period signal is generated based on the code rate NCO phase. In one embodiment, the integration period signal is generated by an integration period counter. At step 1118, signals are multiplied to generate a first product. In one embodiment, the signals multiplied comprise a signal output from the commutator which receives the GNSS signal from the ADC. The signals multiplied also include a signal output from the code generator, and the intermediate frequency phase from the IFNCO. In one embodiment, the first product is stored after it is generated. At step 1120, signals are multiplied to generate a second product. In one embodiment, the signals multiplied comprise the signal output from the commutator, from the strobe signal, and the intermediate frequency phase from the intermediate frequency NCO. In one embodiment, the second product is stored after it is generated. At step 1122, the navigation receiver is controlled based on the tick signal, the relaxed tick signal, first product, and second product.

The foregoing Detailed Description is to be understood as being in every respect illustrative and exemplary, but not restrictive, and the scope of the inventive concept disclosed herein should be interpreted according to the full breadth permitted by the patent laws. It is to be understood that the embodiments shown and described herein are only illustrative of the principles of the inventive concept and that various modifications may be implemented by those skilled in the art without departing from the scope and spirit of the inventive concept. Those skilled in the art could implement various other feature combinations without departing from the scope and spirit of the inventive concept.

1. A navigation receiver comprising
an RF-path configured to receive Global Navigation Satellite System (GNSS) signals from an antenna and transmit the GNSS signals at an intermediate frequency;
an analog to digital convertor (ADC) configured to receive the GNSS signals from the RF-path at the intermediate frequency and sample the GNSS signals at frequency CLKnav;
a time scale generator configured to generate a tick signal and a relax tick signal;
a channel configured to receive the GNSS signals from the ADC, the channel comprising:
an intermediate frequency numerically controlled oscillator (NCO) configured to generate a pulse at the intermediate frequency and at an intermediate frequency phase;
a code rate NCO (CRNCO) configured to generate a code rate NCO signal having a code rate NCO phase and a code rate NCO frequency;
a code generator configured to generate a code signal based on the code rate NCO frequency;
a strobe generator configured to generate a strobe signal based on the shape of the code signal and the code rate NCO phase;
an integration period counter configured to generate an integration period signal based on the code rate NCO frequency;
a commutator configured to receive the GNSS signal from the ADC;
a correlator configured to multiply a signal output from the commutator, from the code generator, and the intermediate frequency phase from the intermediate frequency NCO to generate a first product, and configured to store the first product during the integration period, and configured to multiply the signal output from the commutator, from the strobe signal, and the intermediate frequency phase from the intermediate frequency NCO to generate a second product, and configured to store the second product during the integration period; and
a CPU controlling the navigation receiver and reading data from the correlator.

2. The navigation receiver of claim 1, wherein the CRNCO is further configured to generate the code rate NCO frequency based on one of the tick signal, the relax tick signal, the integration period signal, and an immediate signal output from update CRNCO.

3. The navigation receiver of claim 1, wherein the CRNCO is further configured to generate the code rate NCO phase shift based on one of the tick signal, the relax tick signal, the integration period signal, and an immediate signal output from update CRNCO.

4. The navigation receiver of claim 1, further comprising an update lock phase CRNCO in communication with the CRNCO, the update lock phase CRNCO configured to generate a CRNCO lock phase update signal based on one of the tick signal, the relax tick signal, the integration period signal, and an immediate signal output from update CRNCO.

5. The navigation receiver of claim 1, wherein an intermediate frequency NCO frequency update signal is selected from one of the tick signal, the relax tick signal, the integration period signal, and an immediate signal output from update IFNCO.

6. The navigation receiver of claim 1, wherein an intermediate frequency NCO phase shift update signal is selected from one of the tick signal, the relax tick signal, the integration period signal, and an immediate signal update IFNCO.

7. The navigation receiver of claim 1, further comprising an update frequency IFNCO that is configured to generate an intermediate frequency NCO frequency update signal that causes a current intermediate frequency phase to be locked in an intermediate frequency NCO, the intermediate frequency NCO frequency update signal based on one of the tick signal, the relax tick signal, the integration period signal, and an immediate signal output from update IFNCO.

8. The navigation receiver of claim 1, wherein the CPU is configured to copy a code frequency signal into a buffer register of the code rate NCO based on an update signal.

9. The navigation receiver of claim 1, wherein the CPU is configured to copy an intermediate frequency control signal into an interface register of a buffer register in the intermediate frequency NCO based on an update signal.

10. The navigation receiver of claim 1, wherein the code rate NCO is further configured to phase shift a code rate NCO code phase based on an update signal.

11. The navigation receiver of claim 1, wherein the intermediate frequency NCO is further configured to phase shift an intermediate frequency in the intermediate frequency NCO based on an update signal.

12. The navigation receiver of claim 1, wherein the CPU is configured to store a value of a primary buffer in the correlator over an integration period.

13. The navigation receiver of claim 1, wherein the CPU is configured to copy data from a primary buffer based on the tick signal and storing the data from the primary buffer in a secondary buffer.

14. The navigation receiver of claim 1, wherein the period of the relax tick signal is a multiple of the period of the tick signal.

15. A method for operating a navigation receiver comprising:
receiving GNSS signals;
sampling the GNSS signals at a frequency CLKnav;
generating a tick signal and a relax tick signal;
generating a pulse at an intermediate frequency and at an intermediate frequency phase;
generating a code rate NCO signal having a code rate NCO phase and a code rate NCO frequency;
generating a code signal based on the code rate NCO frequency;
generating a strobe signal based on the shape of the code signal and the code rate NCO phase;
generating an integration period signal based on the code rate NCO frequency;
multiplying a signal output from a commutator receiving the sampled GNSS signal, the code signal, and the intermediate frequency phase to generate a first product stored during the period identified by the integration period signal;
multiplying the signal output from a commutator receiving the sampled GNSS signal, the strobe signal, and the intermediate frequency phase to generate a second product stored during the period identified by the integration period signal; and
controlling the navigation receiver based on the tick signal, relaxed tick signal, the first product, and the second product.

16. The method of claim 15, further comprising:
generating, by the code rate NCO, the code rate NCO frequency based on one of the tick signal, the relax tick signal, the integration period signal, and an immediate signal output from one of an update code rate NCO or an update IFNCO.

17. The method of claim 15, further comprising:
generating, by the code rate NCO, the code rate NCO phase shift based on one of the tick signal, the relax tick signal, the integration period signal, and an immediate signal output from one of an update code rate NCO or an update IFNCO.

18. A navigation receiver comprising:
means for receiving GNSS signals;
means for sampling the GNSS signals at a frequency CLKnav;
means for generating a tick signal and a relax tick signal;
means for generating a pulse at an intermediate frequency and at an intermediate frequency phase;
means for generating a code rate NCO signal having a code rate NCO phase and a code rate NCO frequency;
means for generating a code signal based on the code rate NCO frequency;
means for generating a strobe signal based on the shape of the code signal and the code rate NCO phase;
means for generating an integration period signal based on the code rate NCO frequency;
means for multiplying a signal output from a commutator receiving the sampled GNSS signal, the code signal, and the intermediate frequency phase to generate a first product;
means for storing the first product during the period identified by the integration period signal;
means for multiplying the signal output from a commutator receiving the sampled GNSS signal, the strobe signal, and the intermediate frequency phase to generate a second product;
means for storing the second product during period identified by the integration period signal; and
means for controlling the GNSS receiver based on the tick signal, relaxed tick signal, the first product, and the second product.

19. The navigation receiver of claim 18, further comprising:
means for generating the code rate NCO frequency based on one of the tick signal, the relax tick signal, the integration period signal, and an immediate signal output from update CRNCO.

20. The navigation receiver of claim 18, further comprising:
means for generating the code rate NCO phase based on one of the tick signal, the relax tick signal, the integration period signal, and an immediate signal output from update CRNCO.

21. The method of claim 15, further comprising:
generating, by an intermediate frequency NCO, an intermediate frequency NCO frequency based on one of the tick signal, the relax tick signal, the integration period signal, and an immediate signal output from update IFNCO.

22. The method of claim 15, further comprising:
generating, by an intermediate frequency NCO, an intermediate frequency NCO phase shift based on one of the tick signal, the relax tick signal, the integration period signal, and an immediate signal output from update IFNCO.

23. The navigation receiver of claim 18, further comprising:
means for generating an intermediate frequency NCO frequency based on one of the tick signal, the relax tick signal, the integration period signal, and an immediate signal output from update IFNCO.

24. The navigation receiver of claim 18, further comprising:
means for generating an intermediate frequency NCO phase shift based on one of the tick signal, the relax tick signal, the integration period signal, and an immediate signal output from update IFNCO.
